(19) United States
(12) Patent Application Publication
(10) Pub. No.: US 2024/0327688 A1
(43) Pub. Date: Oct. 3, 2024

(54) EPOXY RESIN COMPOSITION

(71) Applicant: Shin-Etsu Chemical Co., Ltd., Tokyo (JP)

(72) Inventors: Naoyuki KUSHIHARA, Matsuida-machi (JP); Kazuaki SUMITA, Matsuida-machi (JP); Akira YAJIMA, Matsuida-machi (JP)

(21) Appl. No.: 18/617,769

(22) Filed: Mar. 27, 2024

(30) Foreign Application Priority Data
Mar. 29, 2023 (JP) 2023-053277

(51) Int. Cl. C09J 163/00; C08K 3/36; C08K 5/00; C08K 5/3492; C08K 9/10; C08L 63/00

(52) U.S. Cl. CPC C09J 163/00; C08K 3/36; C08K 5/0025; C08K 5/3492; C08K 9/10; C08L 63/00; C08L 2203/20; C08L 2205/05; C08L 2312/04; C09J 2463/00

(57) ABSTRACT

One of the objects of the present invention is to provide an epoxy resin composition that has excellent curability and storage stability, and that gives a cured product with excellent adhesive strength. The present invention provides an epoxy resin composition comprising (A) an epoxy resin, (B) a phenolic resin in a form of liquid at 25° C., having, per molecule, one or more functional groups having an aliphatic carbon-carbon double bond, (C) a microcapsule-type curing accelerator, (D) an imidazole compound having a triazine ring, and (E) an inorganic filler.

### CROSS-REFERENCE TO RELATED APPLICATIONS

This application claims the benefits of Japanese Patent Application No. 2023-53277 filed on Mar. 29, 2023, the contents of which are hereby incorporated by reference.

### FIELD OF THE INVENTION

The present invention relates to an epoxy resin composition. More specifically, the present invention relates to an epoxy resin composition comprising a liquid phenolic resin.

### BACKGROUND OF THE INVENTION

Epoxy resin compositions have excellent adhesive strength as well as excellent heat resistance and electrical characteristics, and are thus used as sealing materials or adhesives in the fields of electrical or electronic equipment parts and automobile parts.

Epoxy resin compositions generally comprises curing agents that react with epoxy groups. Examples of curing agents include amine-based curing agents, phenol-based curing agents, acid anhydride-based curing agents, and thiol-based curing agents. Among these, phenol-based curing agents are used in the fields of power semiconductors due to their excellent heat resistance reliability and moisture resistance reliability (Patent Literature 1).

A solid phenol-based curing agent in which an allyl group or an alkyl group is introduced can be used as liquid phenolic resins. A cured product obtained from an epoxy resin and the liquid phenolic resin is used for electronic material applications, such as underfill materials and adhesives, due to their excellent moisture resistance reliability (Patent Literatures 2 and 3).

However, the introduction of the allyl group into the phenol-based curing agent makes the reactivity of phenolic hydroxyl groups lower and a high temperature and long curing time are required. Accordingly, for the purpose of improving the reactivity, imidazole compounds and phosphorus compounds are used as catalysts (Patent Literature 4).
Patent Literature 1: Japanese Patent Application Laid-Open No. 2021-063145
Patent Literature 2: Japanese Patent Application Laid-Open No. 2010-241877
Patent Literature 3: Japanese Patent Application Laid-Open No. 2016-037529
Patent Literature 4: WO 2020/262061

### BRIEF SUMMARY OF THE INVENTION

However, it is difficult to satisfy both curability as well as storage stability, and further there is a problem of insufficient adhesive strength, which has not been solved. Therefore, one of the objects of the present invention is to provide an epoxy resin composition that has excellent curability and storage stability, and that gives a cured product with excellent adhesive strength.

As a result of extensive research to achieve the above object, the present inventors have found that a composition comprising a liquid phenolic resin having an aliphatic carbon-carbon double bond, such as an allyl group, together with a microcapsule-type curing accelerator and an imidazole compound having a triazine ring, has excellent curability and storage stability, and provides a cured product with excellent adhesive strength.

That is, the present invention provides the following epoxy resin composition.

[1] An epoxy resin composition comprising (A) an epoxy resin, (B) a phenolic resin in a form of liquid at 25° C., having, per molecule, one or more functional groups having an aliphatic carbon-carbon double bond, (C) a microcapsule-type curing accelerator, (D) an imidazole compound having a triazine ring, and (E) an inorganic filler.

The present invention also provides the epoxy resin composition further having at least one constitute selected from the following constitutes [2] to [10].

[2] The epoxy resin composition, wherein the epoxy resin (A) has one or more aromatic rings per molecule.

[3] The epoxy resin composition, wherein the epoxy resin (A) comprises one or more selected from the groups consisting of a bisphenol A-type epoxy resin, a bisphenol F-type epoxy resin, a naphthalene-type epoxy resin, and an aminophenol-type epoxy resin.

[4] The epoxy resin composition, wherein the functional group having an aliphatic carbon-carbon double bond in the liquid phenolic resin (B) is an allyl group or a vinyl group.

[5] The epoxy resin composition, wherein the liquid phenolic resin (B) is represented by the following formula (1):

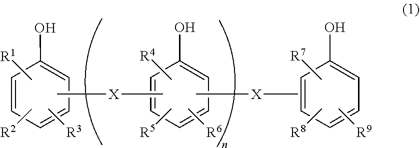

wherein R¹ to R⁹ are, independently of each other, a hydrogen atom, an optionally substituted monovalent hydrocarbon group having 1 to 25 carbon atoms and not having an aliphatic carbon-carbon double bond, an allyl group, a vinyl group, a (meth)acryloxy group, a styryl group, or a hydroxyl group; one or more of R¹ to R⁹ are allyl groups or vinyl groups; n is a number of 0 to 10; and X is a divalent linking group selected from the group consisting of the following formulas:

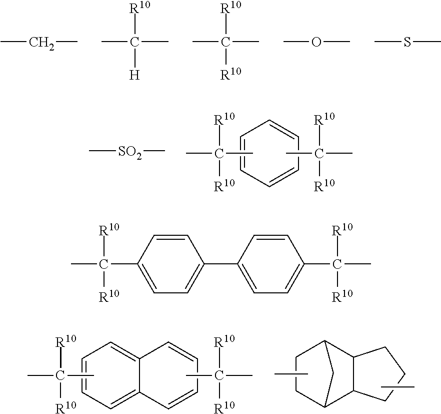

wherein R¹⁰ is, independently of each other, a hydrogen atom or a methyl group.

[6] The epoxy resin composition, wherein the molar equivalent ratio of phenolic hydroxyl groups in the liquid phenolic resin (B) is 0.1 to 2.0, per molar equivalent of epoxy groups in the epoxy resin (A).

[7] The epoxy resin composition, wherein an amount of the microcapsule-type curing accelerator (C) is 1 to 200 parts by mass, relative to 100 parts by mass of the epoxy resin (A).

[8] The epoxy resin composition, wherein the microcapsule-type curing accelerator (C) comprises a core comprising a curing accelerator selected from a phosphorus compound, a tertiary amine compound, an imidazole compound, a urea compound, and an amine adduct compound.

[9] The epoxy resin composition, wherein an amount of the imidazole compound having the triazine ring (D) is 0.1 to 5 parts by mass, relative to 100 parts by mass of the epoxy resin (A).

[10] The epoxy resin composition, wherein an amount of the inorganic filler (E) is 10 to 20,000 parts by mass, relative to 100 parts by mass of the epoxy resin (A).

Further, the present invention provides an encapsulant for a semiconductor element comprising the epoxy resin composition, an adhesive comprising the epoxy resin composition, and a semiconductor device having a cured product of the epoxy resin composition.

The epoxy resin composition of the present invention has excellent curability and storage stability, and provides a cured product with excellent adhesive strength.

### DETAILED DESCRIPTION OF THE INVENTION

The following describes the present invention in detail.

The epoxy resin composition of the present invention comprises (A) an epoxy resin, (B) a liquid phenolic resin having, per molecule, one or more functional groups having an aliphatic carbon-carbon double bond, (C) a microcapsule-type curing accelerator, (D) an imidazole compound having a triazine ring, and (E) an inorganic filler.

### (A) Epoxy Resin

The epoxy resin (A) is a main component of the present invention, and may be any of generally known epoxy resins. Examples of such epoxy resins include bisphenol-type epoxy resins, such as bisphenol A-type epoxy resin, bisphenol F-type epoxy resin, and bisphenol S-type epoxy resin; novolac-type epoxy resins, such as phenol novolac-type epoxy resin, cresol novolac-type epoxy resin, bisphenol A novolac-type epoxy resin, and bisphenol F novolac-type epoxy resin; alicyclic epoxy resins, such as dicyclopentadiene-type epoxy resin and 3,4-epoxycyclohexenylmethyl-3′,4′-epoxycyclohexene carboxylate; polyfunctional phenol-type epoxy resins, such as resorcinol-type epoxy resin and resorcinol novolac-type epoxy resin; aminophenol-type epoxy resin, stilbene-type epoxy resin, triazine skeleton-containing epoxy resin, fluorene skeleton-containing epoxy resin, triphenolalkane-type epoxy resin, biphenyl-type epoxy resin, xylylene-type epoxy resin, biphenyl aralkyl-type epoxy resin, naphthalene-type epoxy resin, diglycidyl ether compounds of polycyclic aromatics such as anthracene, silicone-modified epoxy resin, phosphorus-containing epoxy resins obtained by introducing phosphorus compounds into these resins, and the like. These may be used singly or in combination of two or more.

Among these, preferred is an epoxy resin in a form of liquid at room temperature (25° C.). For being liquid, the viscosity at 25° C. is preferably 1 mPa·s to 1,000 Pa·s, or more preferably 10 mPa·s to 100 Pa·s. The viscosity as mentioned herein is a value determined by the method described in the Japanese Industrial Standards (JIS) Z8803:2011.

Further, in terms of heat resistance reliability and moisture resistance reliability, the component (A) is preferably an epoxy resin having one or more aromatic rings per molecule. The epoxy resin is preferably a bisphenol A-type epoxy resin, a bisphenol F-type epoxy resin, a naphthalene-type epoxy resin, or an aminophenol-type epoxy resin.

### (B) Liquid Phenolic Resin

The liquid phenolic resin (B) is a curing agent for epoxy resins, and is added for the purpose of reacting with the epoxy groups in the epoxy resin (A). The liquid phenolic resin is liquid at room temperature (25° C.). The liquid phenolic resin preferably has a viscosity at 25° C. of 100 mPa·s to 500 Pas, or more preferably 1,000 mPa·s to 50 Pa·s. Within these ranges, dispersion in the epoxy resin is easier. The viscosity as mentioned herein is a value determined by the method described in JIS Z8803:2011.

The liquid phenolic resin (B) has one or more functional groups having an aliphatic carbon-carbon double bond per molecule. Any known liquid phenolic resin may be used as long as it has, per molecule, one or more functional groups having an aliphatic carbon-carbon double bond. The functional group having an aliphatic carbon-carbon double bond is preferably an alkenyl group having 2 to 10 carbon atoms such as a vinyl or allyl group, an alkenyl aryl group having 8 to 20 carbon atoms such as a styryl group, an acryloxy group, a methacryloxy group. Among these, preferred is a liquid phenolic resin having an allyl group or a vinyl group as a functional group having an aliphatic carbon-carbon double bond.

The liquid phenolic resin (B) is preferably represented by the following formula (1):

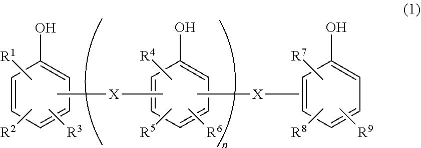

In formula (1), R¹ to R⁹ are, independently of each other, a hydrogen atom, an optionally substituted monovalent hydrocarbon group having 1 to 25 carbon atoms and not having an aliphatic carbon-carbon double bond, an allyl group, a vinyl group, a (meth)acryloxy group, a styryl group, or a hydroxyl group; and one or more of R¹ to R⁹ are allyl groups or vinyl groups. More preferably, each aromatic ring has at least one allyl group or vinyl group. n is a number of 0 to 10, preferably 0 or 1 to 5. The liquid phenolic resin may be a mixture of compounds having a plurality of n. X is a divalent linking group selected from the group consisting of the following formulas.

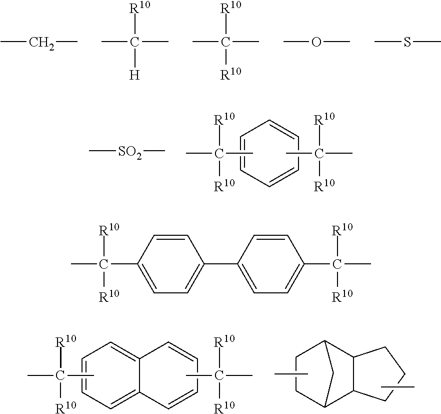

wherein R¹⁰ is, independently of each other, a hydrogen atom or a methyl group.

In formula (1), examples of the optionally substituted hydrocarbon group having 1 to 25 carbon atoms and not having a functional group having an aliphatic carbon-carbon double bond include alkyl groups, such as methyl, ethyl, n-propyl, isopropyl, n-butyl, isobutyl, tert-butyl, pentyl, neopentyl, hexyl, cyclohexyl, octyl, decyl, pentadecane, and eicosane groups; aryl groups, such as phenyl and tolyl groups; aralkyl groups, such as benzyl and phenylethyl groups; and halogen-substituted monovalent hydrocarbon groups wherein a part or all of the hydrogen atoms bonded to a carbon atom of the aforesaid groups is substituted with a halogen atom. Preferred are methyl, ethyl, isopropyl, and tert-butyl groups.

Among the liquid phenolic resins represented by formula (1), allyl group-containing phenolic resins, such as bisphenol A-type allyl phenolic resins, bisphenol F-type allyl phenolic resins, novolac-type allyl phenolic resins, aralkyl-type allyl phenolic resins, and resorcinol-type allyl phenolic resins, are preferred in terms of viscosity and adhesive strength. These may be used singly or in combination of two or more.

The amount of the liquid phenolic resin (B) is such that the molar equivalent ratio of phenolic hydroxyl groups in the liquid phenolic resin (B) is preferably 0.1 to 2.0, more preferably 0.2 to 1.8, or even more preferably 0.4 to 1.5, per molar equivalent of epoxy groups in the epoxy resin (A). If the molar equivalent ratio is less than 0.1, unreacted epoxy groups remain, which may reduce adhesion of the cured product. If the molar equivalent ratio exceeds 2.0, unreacted phenolic hydroxyl groups remain, which may cause strength deterioration of the cured product during high-temperature storage.

### (C) Microcapsule-Type Curing Accelerator

The microcapsule-type curing accelerator (C) is added for the purpose of promoting the curability of the epoxy resin (A) and the liquid phenolic resin (B). The microcapsule-type curing accelerator contains a shell material and a core composed of a curing accelerator component, which is covered with the shell material. In the microcapsule-type curing accelerator, the curing accelerator component is covered with the shell material to be thereby separated from the other components described above and, thereto, improve the storage stability of the epoxy resin composition. The curing accelerator (catalyst) is a component effective for the core material (core particles) of the microcapsules, the reaction temperature (i.e., the temperature at which catalytic action occurs) is preferably 50° C. or more in order to exhibit fast curability at a low temperature of a certain temperature or more and storage stability. Examples of such curing accelerators include phosphorus compounds, tertiary amine compounds, imidazole compounds, urea compounds, and amine adduct compounds such as alicyclic polyamines.

It is also preferable that the microcapsule-type curing accelerator is pre-mixed in advance with an epoxy resin and a curing agent to form a masterbatch microcapsule-type curing accelerator. On account of the masterbatch microcapsule-type, dispersibility of the curing accelerator may be improved.

Examples of phosphorus compounds include triorganophosphine compounds, such as tributylphosphine, triphenylphosphine, tri(methylphenyl)phosphine, tri(nonylphenyl)phosphine, tri(methoxyphenyl)phosphine, diphenyltolylphosphine, and triphenylphosphine triphenylborane; quaternary phosphonium salts, such as tetraphenylphosphonium tetraphenylborate. Among these, preferred are triphenylphosphine and tri(methylphenyl)phosphine.

Examples of tertiary amine compounds include amine compounds having an alkyl group or aralkyl group as a substituent bonded to a nitrogen atom, such as triethylamine, benzyldimethylamine, benzyltrimethylamine, and α-methylbenzyldimethylamine; cycloamidine compounds, such as 1,8-diazabicyclo[5.4.0]undec-7-ene and 1,4-diazabicyclo[2.2.2]octane, as well as phenol salts, octylates, and oleates thereof; salts with organic acids thereof; salts or complex salts with quaternary boron compounds; and the like. Among these, preferred are 1,8-diazabicyclo[5.4.0]undec-7-ene and 1,4-diazabicyclo[2.2.2]octane.

Examples of imidazole compounds include 2-methylimidazole, 2-ethylimidazole, 2-undecylimidazole, 2,4-dimethylimidazole, 2-heptadecylimidazole, 1,2-dimethylimidazole, 1,2-diethylimidazole, 2-phenyl-4-methylimidazole, 2,4,5-triphenylimidazole, 2-ethyl-4-methylimidazole, 2-phenylimidazole, 1-benzyl-2-phenylimidazole, 1-cyanoethyl-2-methylimidazole, 1-cyanoethyl-2-undecylimidazole, 1-benzyl-2-methylimidazole, 2-phenyl-4,5-dihydroxymethylimidazole, 2-allyl-4,5-diphenylimidazole, 2-phenyl-4-methyl-5-hydroxymethylimidazole, and the like. Among these, preferred are 2-phenyl-4-methyl-5-hydroxymethylimidazole, 2-phenyl-4,5-dihydroxymethylimidazole, 2-methylimidazole, 2-ethyl-4-methylimidazole, 2-ethylimidazole, 1,2-dimethylimidazole, 1,2-diethylimidazole, 2,4-dimethylimidazole, and 2-phenyl-4-methylimidazole.

Examples of urea compounds include N, N-dimethyl-N′-phenylurea, N, N-dimethyl-N′-(3,4-dichlorophenyl) urea, 4,4′-methylenebis(phenyldimethylurea), aromatic dimethylurea compounds, aliphatic dimethylurea compounds, toluene bis-dimethylurea, and N′-[3-[[[(dimethylamino)carbonyl]amino]methyl]-3,5,5-trimethylcyclohexyl]-N,N-dimethylurea. Among these, preferred are aromatic dimethylurea compounds and aliphatic dimethylurea compounds.

Examples of amine adduct compounds include compounds having an amino group obtained by reacting at least one compound selected from the group consisting of carboxylic acid compounds, phenol compounds, isocyanate compounds, and epoxy resins, with an amine compound. Among these, the main component of the microcapsule core is preferably an amine adduct compound obtained by reacting an isocyanate resin or an epoxy resin with an amine compound.

Examples of carboxylic acid compounds include succinic acid, adipic acid, sebacic acid, phthalic acid and dimer acid.

Examples of phenol compounds include monophenols, such as carbolic acid, cresol, xylenol, carvacrol, thymol, and naphthol; and polyvalent phenols, such as catechol, resorcinol, hydroquinone, bisphenol A, bisphenol F, pyrogallol, and phloroglucinol.

Examples of isocyanate compounds include ethylene diisocyanate, propylene diisocyanate, butylene diisocyanate, hexamethylene diisocyanate, trimethylhexamethylene diisocyanate, isophorone diisocyanate, 4,4′-dicyclohexylmethane diisocyanate, norbornane diisocyanate, 1,4-isocyanatocyclohexane, 1,3-bis(isocyanatomethyl)-cyclohexane, 1,3-bis(2-isocyanatopropyl-2-yl)-cyclohexane, tolylene diisocyanate, 4,4′-diphenylmethane diisocyanate, xylene diisocyanate and 1,5-naphthalene diisocyanate.

Examples of epoxy compounds include butyl glycidyl ether, hexyl glycidyl ether, phenyl glycidyl ether, allyl glycidyl ether, para-tert-butylphenyl glycidyl ether, paraxylyl glycidyl ether; bisphenol-type epoxy resins, such as bisphenol A-type epoxy resin, bisphenol F-type epoxy resin, and bisphenol S-type epoxy resin; novolac-type epoxy resins, such as phenol novolac-type epoxy resin, cresol novolac-type epoxy resin, bisphenol A novolac-type epoxy resin, and bisphenol F novolac-type epoxy resin; alicyclic epoxy resins, such as dicyclopentadiene-type epoxy resin and 3,4-epoxycyclohexenylmethyl-3′,4′-epoxycyclohexenecarboxylate; polyfunctional phenol-type epoxy resins, such as resorcinol-type epoxy resin and resorcinol novolac-type epoxy resin; stilbene-type epoxy resin, triazine skeleton-containing epoxy resin, fluorene skeleton-containing epoxy resin, triphenolalkane-type epoxy resin, biphenyl-type epoxy resin, xylylene-type epoxy resin, biphenyl aralkyl-type epoxy resin, naphthalene-type epoxy resin, diglycidyl ether compounds of polycyclic aromatics such as anthracene, and phosphorus-containing epoxy resins obtained by introducing phosphorus compounds into these resins.

Examples of amine compounds include methylamine, ethylamine, propylamine, butylamine, ethylenediamine, 1,2-propanediamine, tetramethyleneamine, 1,5-diaminopentane, hexamethylenediamine, 2,4,4-trimethylhexamethylenediamine, 2,2,4-triethylhexamethyldiamine, 1,2-diaminopropane, diethylenetriamine, triethylenetetramine, tetraethylenepentamine, cyclohexylamine, isophoronediamine, 1,3-bisaminomethylcyclohexane, aminoethylpiperazine, diethylaminopropylamine, dimethylamine, diethylamine, dipropylamine, dibutylamine, dipentylamine, dihexylamine, dimethanolamine, diethanolamine, dipropanolamine, dicyclohexylamine, and piperazine.

These curing accelerators contained in the microcapsules may be used singly or in combination of two or more.

The shell material that forms the curing accelerator into microcapsules is required to have a melting point of 50 to 90° C., from the viewpoint of maintaining storage stability and ensuring fast curability. The material of the shell material is not particularly limited as long as it has such a melting point, and any of known materials may be used. Examples of shell materials include polymers obtained by (co)polymerizing one or more monomers selected from the following: (meth)acrylic monomers such as alkyl esters having 1 to 8 carbon atoms, such as acrylic esters, itaconic esters and crotonic esters; monomers in which the alkyl groups of these alkyl esters have substituents, such as allyl groups; monofunctional monomers, such as styrene, α-methylstyrene, acrylonitrile, methacrylonitrile, and vinyl acetate; and polyfunctional monomers, such as ethylene glycol di(meth)acrylate, polyethylene glycol di(meth)acrylate, divinylbenzene, bisphenol A di(meth)acrylate, and methylenebis(meth)acrylamide. Among these, preferred are polymers of (meth)acrylate monomers.

The microcapsule-type curing accelerator contains a shell material mentioned above and a core component covered with the shell material, in which the core component is composed of a curing accelerator such as an imidazole compound or a tertiary amine compound. The method for preparing the microcapsule-type curing accelerator is not particularly limited. For examples, the following methods (a) to (c) may be used.

(a) A method of dissolving or dispersing a shell material and core particles of a microcapsule-type curing accelerator in a solvent as a dispersion medium and, then, reducing the solubility of the shell material in the dispersion medium so as to precipitate the shell on the surface of the core particles of the microcapsule-type curing accelerator.

(b) A method of dispersing core particles of a microcapsule-type curing accelerator in a dispersion medium and, then, adding a shell material into the dispersion medium so as to precipitate the shell on the surface of the core particles of the microcapsule-type curing accelerator.

(c) A method of adding a shell material into a dispersion medium and, then, reacting them on the surface of core particles so as to form a shell on the surface of core particles of a microcapsule-type curing accelerator.

Examples of the dispersion media used in the above methods (a) to (c) include solvents and resins. Examples of such solvents include acetone, methyl ethyl ketone, methyl isobutyl ketone, ethyl acetate, n-butyl acetate, propylene glycol monomethyl ethyl ether acetate, benzene, toluene, xylene, cyclohexane, methanol, ethanol, isopropanol, n-butanol, butyl carbitol, water, and the like. Examples of resins include epoxy resins, phenolic resins, maleimide resins, cyanate ester resins, silicone resins, and the like. Among these, preferred as dispersion media with good dispersibility are aromatic hydrocarbons such as toluene, and alcohols such as n-butanol.

The microcapsule-type curing accelerator used in the composition of the present invention preferably has an average particle size of 0.1 to 10 μm, or particularly desirably an average particle size of 1 to 5 μm. If the average particle size is too small, the specific surface area increases, which may increase the viscosity of the epoxy resin composition during mixing. If the average particle size exceeds 10 μm, dispersion in the epoxy resin composition becomes uneven, which may cause a decrease in reliability. The average particle size is a volume average particle size determined by a laser diffraction method.

The amount of the component (C) is preferably 1 to 200 parts by mass, more preferably 2.5 to 150 parts by mass, or particularly preferably 3 to 100 parts by mass, relative to 100 parts by mass of the epoxy resin (A). When the amount of the component (C) is within the above ranges, the balance between the storage stability and moisture resistance of the composition may not become worse, or the curing speed during molding may not be very slow or fast.

### (D) Imidazole Compound Having a Triazine Ring

The imidazole compound having a triazine ring is contained for the purposes of promoting the reaction between the epoxy resin and the liquid phenolic resin, and improving the adhesive strength to various substrates. The type of imidazole compound having a triazine ring is not particularly limited. Any of known imidazole compounds having a triazine ring may be used. Examples of imidazole compounds include 2,4-diamino-6-[2′-methylimidazolyl(1′)]-ethyl-s-triazine, 2,4-diamino-6-[2′-undecylimidazolyl(1′)]-ethyl-s-triazine, 2,4-diamino-6-[2′-ethyl-4-methylimidazolyl(1′)]-ethyl-s-triazine, an isocyanuric acid adduct of 2,4-diamino-6-[2′-methylimidazolyl(1′)]-ethyl-s-triazine, an isocyanuric acid adduct of 2-phenylimidazole, and an isocyanuric acid adduct of 2-methylimidazole.

The amount of the component (D) is preferably 0.1 to 10 parts by mass, or particularly more preferably 0.2 to 5 parts by mass, relative to 100 parts by mass of the epoxy resin (A). When the amount of the component (D) is within the above ranges, the balance between the storage stability and moisture resistance of the composition may not become worse.

The inorganic filler (E) is contained for the purpose of improving the resin strength of the epoxy resin composition and reducing thermal expansion. The type of inorganic filler is not particularly limited, and may be any of known inorganic fillers. Examples of such inorganic fillers include silicas (e.g., fused silica, crystalline silica, and cristobalite), alumina, silicon nitride, aluminum nitride, boron nitride, titanium oxide, glass fibers, and magnesium oxide. The average particle size and shape of the inorganic filler may be selected depending on the purpose.

In order to enhance the bond strength between the epoxy resin and the inorganic filler, the inorganic filler (E) is preferably surface-treated in advance with a coupling agent, such as a silane coupling agent or a titanate coupling agent. Examples of such coupling agents include epoxy silanes, such as γ-glycidoxypropyltrimethoxysilane, γ-glycidoxypropylmethyldiethoxysilane, and β-(3,4-epoxycyclohexyl)ethyltrimethoxysilane; aminosilanes, such as N-β(aminoethyl)-γ-aminopropyltrimethoxysilane, reaction products of imidazole and γ-glycidoxypropyltrimethoxysilane, γ-aminopropyltriethoxysilane, and N-phenyl-γ-aminopropyltrimethoxysilane; and mercaptosilanes, such as γ-mercaptosilane and γ-episulfidoxypropyltrimethoxysilane. The amount of the coupling agent and a method of surface-treating in the surface treatment may follow a conventionally known method, and are not particularly limited in the present invention.

The amount of the inorganic filler (E) is preferably 10 to 20,000 parts by mass, more preferably 15 to 10,000 parts by mass, or even more preferably 20 to 3,000 parts by mass, relative to 100 parts by mass of the epoxy resin (A).

### (F) Other Additives

In addition to the components (A) to (E), other additives (F) may be added, if necessary, to the epoxy resin composition of the present invention as long as the object and effects of the present invention are not impaired. Examples of the additives (F) include antioxidants, flame retardants, ion-trapping agents, adhesion-imparting agents, stress-reducing agents, and colorants.

An antioxidant is added for the purpose of preventing the oxidative deterioration of the cured product of the epoxy resin composition when stored at high temperatures. The antioxidant may be any of known antioxidants and is not particularly limited. Preferred among such antioxidants are phenol-based antioxidants, sulfur-based antioxidants, and phosphorus-based antioxidants, and particularly preferred are phenol-based antioxidants. Further, the melting point of phenol-based antioxidants is preferably 80 to 250° C., more preferably 90 to 240° C., or particularly preferably 100 to 220° C.

Examples of phenol-based antioxidants include n-octadecyl-3-(3,5-di-t-butyl-4-hydroxyphenyl) propionate, n-octadecyl-3-(3,5-di-t-butyl-4-hydroxyphenyl)acetate, neododecyl-3-(3,5-di-t-butyl-4-hydroxyphenyl) propionate, dodecyl-2-(3,5-di-t-butyl-4-hydroxyphenyl) propionate, ethyl-3-(3,5-di-t-butyl-4-hydroxyphenyl) isobutyrate, octadecyl-3-(3,5-di-t-butyl-4-hydroxyphenyl) isobutyrate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3-(3,5-di-t-butyl-4-hydroxyphenyl) propionate, 2-(2-stearoyloxyethylthio)ethyl-7-(3-methyl-5-t-butyl-4-hydroxyphenyl) heptanoate, 2-hydroxyethyl-3-(3-methyl-5-t-butyl-4-hydroxyphenyl) propionate, pentaerythritol tetrakis[3-(3,5-di-t-butyl-4-hydroxyphenyl) propionate], 3-(3,5-di-tert-butyl-4-hydroxyphenyl) stearyl propionate, 1,3,5-tris[[3,5-bis(1,1-dimethylethyl)-4-hydroxyphenyl]methyl]-1,3,5-triazine-2,4,6(1H,3H,5H)-trione, 1,1,3-tris(2-methyl-4-hydroxy-5-tert-butylphenyl)butane, 4,4′-butylidene bis(6-tert-butyl-m-cresol), pentaerythritol tetrakis[3-(3,5-di-tert-butyl-4-hydroxyphenyl)propionate], and 2,2′-dimethyl-2,2′-(2,4,8,10-tetraoxaspiro[5.5]undecane-3,9-diyl)dipropane-1,1′-diyl=bis[3-(3-tert-butyl-4-hydroxy-5-methylphenyl)propanoate].

Examples of sulfur-based antioxidants include dilauryl-3,3′-thiodipropionate, dimyristyl-3,3′-thiodipropionate, distearyl-3,3′-thiodipropionate, ditridecyl-3,3′-thiodipropionate, pentaerythrityl tetrakis(3-laurylthiopropionate), and bis[3-(dodecylthio) propionic acid]2,2-bis[[3-(dodecylthio)-1-oxopropyloxy]methyl]-1,3-propanediyl.

Examples of phosphorus-based antioxidants include tridecyl phosphite, triphenyl phosphite, tris(2,4-di-t-butylphenyl) phosphite, 2-ethylhexyl diphenyl phosphite, diphenyl tridecyl phosphite, 2,2-methylenebis(4,6-di-t-butylphenyl) octyl phosphite, distearyl pentaerythritol diphosphite, bis(2,6-di-t-butyl-4-methylphenyl) pentaerythritol diphosphite, 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine, and 3,9-bis(octadecyloxy)-2,4,8,10-tetraoxa-3,9-diphosphaspiro[5.5]undecane.

These may be mixed singly or in combination of two or more.

A flame retardant is added for the purpose of imparting flame retardancy. The flame retardant is not particularly limited and may be any of known flame retardants. Examples of flame retardants include phosphazene compounds, silicone compounds, zinc molybdate-supported talc, zinc molybdate-supported zinc oxide, aluminum hydroxide, magnesium hydroxide, and molybdenum oxide.

An ion-trapping agent is added for the purposes of capturing ionic impurities contained in the epoxy resin composition and preventing thermal deterioration and moisture absorption deterioration. The type of ion-trapping agent is not particularly limited and may be any of known ion-trapping agents. Examples of ion-trapping agents include hydrotalcites, bismuth hydroxide compounds, and rare earth oxides.

An adhesion-imparting agent is added for the purpose of imparting adhesion or stickiness (pressure-sensitive adhesion). The adhesion-imparting agent is not particularly limited, and examples include known adhesion-imparting agents, such as urethane resins, phenolic resins, terpene resins, and silane coupling agents. Among these, preferred are silane coupling agents. Examples of silane coupling agents include n-propyltrimethoxysilane, n-propyltriethoxysilane, n-octyltrimethoxysilane, n-octyltriethoxysilane, phenyltrimethoxysilane, phenyltriethoxysilane, methyltrimethoxysilane, methyltriethoxysilane, β-[methoxy(polyethyleneoxy)propyl]-trimethoxysilane, methoxytri(ethyleneoxy)propyltrimethoxysilane, γ-glycidyloxypropyltrimethoxysilane, γ-aminopropyltrimethoxysilane, γ-mercaptopropyltrimethoxysilane, γ-(methacryloyloxy) propyltrimethoxysilane, γ-isocyanatopropyltriethoxysilane, and γ-isocyanatopropyltrimethoxysilane.

A stress-reducing agent is added for the purpose of reducing the elastic modulus and thermal expansion coefficient of the epoxy resin composition. The stress-reducing agent is not particularly limited, and examples include known stress-reducing agents, such as thermoplastic resins, thermoplastic elastomers, organic synthetic rubbers, and silicones.

Examples of colorants include carbon black, titanium black, and titanium oxide. These may be used singly or in combination of two or more.

The amount of the other additives varies depending on the purpose of the composition, but may be generally 5 mass % or less of the entire epoxy resin composition, excluding the inorganic filler.

The epoxy resin composition of the present invention is preferably liquid at room temperature (25° C.). Further, the epoxy resin composition preferably has a viscosity at 25° C. of 0.1 to 850 Pa·s. The viscosity as mentioned herein is a value determined by the method described in JIS Z8803:2011.

The epoxy resin composition of the present invention may be prepared by a method shown below.

For example, the components (A) to (E) are simultaneously or separately mixed, stirred, dissolved and/or dispersed, optionally with heat treatment, to obtain a mixture of the components (A) to (E). Preferably, the liquid phenolic resin (B) is added to a mixture of the components (A), (C), (D), and (E), followed by stirring, dissolution and/or dispersion and, thereby, obtaining a mixture of the components (A) to (E). Further, depending on the purpose of use, other additives, such as at least one of an antioxidant, a flame retardant, an ion-trapping agent, an adhesion-imparting agent, a stress-reducing agent, and a colorant, may be added and mixed with the mixture of the components (A) to (E). The device for the mixing, stirring, and dispersion is not particularly limited. For example, a milling machine equipped with a stirrer and a heater, a two-roll mill, a three-roll mill, a ball mill, a planetary mixer, or a masscolloider may be used, and these devices may be used in combination as appropriate.

The epoxy resin composition of the present invention is used as a cured product after being cured. The curing conditions for the epoxy resin composition of the present invention are not particularly limited. For example, the epoxy resin composition may be heated at a temperature within the range of 60 to 250° C., or preferably 80 to 230° C., for 30 seconds to 10 hours, or preferably 1 minute to 5 hours. The epoxy resin composition of the present invention may be cured at a high temperature for a short period of time. Therefore, the composition is satisfactory cured even at a temperature within the range of 180 to 230° C. for about 30 seconds to 5 minutes.

The epoxy resin composition of the present invention has excellent adhesive strength, excellent heat resistance and electrical characteristics and, thus, may be used as a sealing material or an adhesive in the fields of electrical or electronic equipment parts, and automobile parts. The epoxy resin composition of the present invention has excellent heat resistance reliability and moisture resistance reliability and, thus, is suitably used in the fields of power semiconductors and the like. Among these, the epoxy resin composition of the present invention is suitably used for a semiconductor device having a support, a semiconductor element placed on the support, and a cured product of an epoxy resin composition that seals the semiconductor element. Particularly, the epoxy resin composition of the present invention is suitably used for a semiconductor device in which the epoxy resin composition fills the gap between the semiconductor element and the support.

### Examples

The present invention will be explained below in further detail with reference to a series of the Examples and the Comparative Examples, though the present invention is in no way limited by these Examples.

In Table 1, the amount indicates parts by mass. The “molar equivalent ratio” described in Table 1 is the ratio of the phenolic hydroxyl group equivalent (active hydrogen equivalent) of the component (B) to the epoxy equivalent of the component (A), and means molar equivalent.

The components used in the Examples and Comparative Examples are as described below.

### (A) Epoxy Resins

(A1) Bisphenol A-type epoxy resin (jER828, viscosity at 25° C.: 5 to 15 Pas, epoxy equivalent: 189 g/eq, manufactured by Mitsubishi Chemical Corporation)
(A2) Aminophenol-type trifunctional epoxy resin (jER630, viscosity at 25° C.: 500 to 1, 500 mPa·s, epoxy equivalent: 100 g/eq, manufactured by Mitsubishi Chemical Corporation)
(A3) Naphthalene-type epoxy resin (HP4032D, viscosity at 25° C.: 20 to 30 Pas, epoxy equivalent: 150 g/eq, manufactured by DIC)

### (B) Liquid Phenolic Resins

(B1) Novolac-type allyl phenolic resin (MEH-8000H, viscosity at 25° C.: 1,600 mPa·s, hydroxyl group equivalent: 141 g/eq, manufactured by UBE) represented by the following formula:

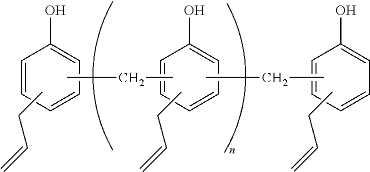

wherein n is an integer of 0 to 4.
(B2) Resorcinol-type allyl phenolic resin (MEH-8400, viscosity at 25° C.: 8,000 mPa·s, hydroxyl group equivalent: 107 g/eq, manufactured by UBE) represented by the following formula:

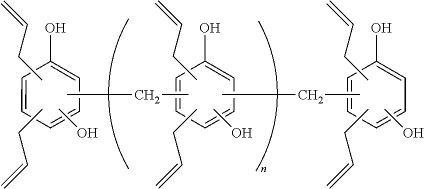

wherein n is an integer of 0 to 4.
(B3) 2,2′-Diallyl bisphenol A (DABPA, viscosity at 25° C.: 20,000 mPa·s, hydroxyl group equivalent: 154 g/eq, manufactured by Daiwa Kasei Industrial Co., Ltd.) represented by the following formula.

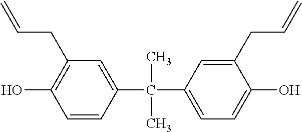 [SMILES: C=CCc1cc(C(C)(C)c2ccc(O)c(CC=C)c2)ccc1O]

### (B′) Epoxy Resin Curing Agent for Comparative Examples

(B′1) Solid epoxy resin curing agent: bisphenol A (solid at 25° C., melting point: 158° C., hydroxyl group equivalent: 114 g/eq, manufactured by Tokyo Chemical Industry Co., Ltd.) represented by the following formula.

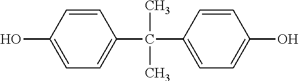 [SMILES: CC(C)(c1ccc(O)cc1)c1ccc(O)cc1]

### (C) Microcapsule-Type Curing Accelerators

(C1) Masterbatch-type curing accelerator containing imidazole-based microcapsules (Novacure HX-3722, average particle size: 2 μm, manufactured by Asahi Kasei Corporation)
(C2) Masterbatch-type curing accelerator containing imidazole-based microcapsules (Novacure HX-3088, average particle size: 2 μm, manufactured by Asahi Kasei Corporation)
(C3) Masterbatch-type curing accelerator containing imidazole-based microcapsules (Novacure HX-3741, average particle size: 2 μm, manufactured by Asahi Kasei Corporation)
(C4) Masterbatch-type curing accelerator containing alicyclic polyamine-based microcapsules (Novacure HXA-5945HP, average particle size: 2 μm, manufactured by Asahi Kasei Corporation)

### (D) Imidazole Compounds Having a Triazine Ring

(D1) 2,4-Diamino-6-[2′-methylimidazolyl(1′)]-ethyl-s-triazine (2MZA-PW, manufactured by Shikoku Chemicals Corporation)
(D2) 2,4-Diamino-6-[2′-undecylimidazolyl(1′)]-ethyl-s-triazine (C11Z-A, manufactured by Shikoku Chemicals Corporation)
(D3) Isocyanuric acid adduct of 2,4-diamino-6-[2′-methylimidazolyl(1′)]-ethyl-s-triazine (2MA-OK, manufactured by Shikoku Chemicals Corporation)

### (E) Inorganic Filler

(E1) Fused spherical silica with an average particle size of 10 μm (manufactured by Tatsumori Ltd.)

### Components for Comparison

(F1) Imidazole compound: 2-ethyl-4-methylimidazole (2E4MZ, manufactured by Shikoku Chemicals Corporation)
(F2) Triazine compound: 2-vinyl-4,6-diamino-1,3,5-triazine (VT, manufactured by Shikoku Chemicals Corporation)

According to the formulations of Examples 1 to 26 and Comparative Examples 1 to 6, the components were mixed by a general method to prepare epoxy resin compositions.

The epoxy resin compositions were evaluated according to the following manners. The results are shown in Table 1.

### [Viscosity]

The viscosity of each epoxy resin composition at 25° C. was determined according to JIS Z 8803:2011. Specifically, the viscosity of the sample after 2 minutes from setting was determined at a measurement temperature of 25° C. using an E-type viscometer.

[Viscosity after Storage at 25° C.]

The viscosity of each epoxy resin composition after being held at 25° C. for 8 hours was determined in the same manner as described above. The ratio of viscosity after 8 hours to the initial viscosity (%) was calculated, and the storage stability was evaluated.

### [Initial Adhesive Strength]

Each epoxy resin composition was applied to a copper frame with a length of 10 mm and a width of 10 mm so that the applied area was 4 mm², and a silicon chip was placed thereon, followed by heating at 200° C. for 1 minute to produce a test piece. The shear adhesive strength at room temperature (25° C.) of the test peace was determined by a bond tester DAGE-SERIES-4000PXY (manufactured by DAGE) and the adhesive strength of the test piece was evaluated.

[Adhesive Strength Retention Rate after High-Temperature and High-Humidity Storage]

Each epoxy resin composition was applied to a copper frame with a length of 10 mm and a width of 10 mm so that the applied area was 4 mm², and a silicon chip was placed thereon, followed by heating at 200° C. for 1 minute to produce a test piece. The shear adhesive strength at room temperature (25° C.) of the test piece was determined by a bond tester DAGE-SERIES-4000PXY (manufactured by DAGE) and the adhesive strength was evaluated.

Further, the obtained test piece was stored in PCT (121° C./100% humidity/2 atm) for 48 hours and then cooled to room temperature, and the shear adhesive strength was determined. More specifically, the adhesive strength retention rate after storage at high-temperature and high-humidity was calculated by the following formula:

Adhesive strength retention rate after storage at high-temperature and high-humidity=[Shear adhesive strength after storage in PCT for 48 hours]/[Initial value]×100(%)

TABLE 1

| | | Example | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| (B) phenolic hydroxyl group/(A)epoxy group, | | 1.0 | 1.0 | 1.0 | 1.0 | 1.0 | 1.0 | 1.0 | 1.0 | 1.0 | 1.0 | 0.8 | 1.2 | 1.5 | 1.0 |
| molar equivalent ratio | | | | | | | | | | | | | | | |
| (A)epoxy resin | (A1) | 100 | 100 | 100 | 100 | 100 | 100 | 100 | 100 | | | 100 | 100 | 100 | 50 |
| | (A2) | | | | | | | | | 100 | | | | | 50 |
| | (A3) | | | | | | | | | | 100 | | | | |
| (B)liquid phenolic resin | (B1) | 85.2 | 85.2 | 85.2 | 85.2 | 85.2 | 85.2 | | | 155.7 | 106 | 107.9 | 70.1 | 55.7 | 121.6 |
| | (B2) | | | | | | | 63.6 | | | | | | | |
| | (B3) | | | | | | | | 93.6 | | | | | | |
| (C)microcapsule-type curing | (C1) | 20.6 | 20.6 | 20.6 | | | | 18.2 | 21.5 | 28.4 | 22.9 | 23.1 | 8.9 | 17.3 | 24.5 |
| accelerator | (C2) | | | | 20.6 | | | | | | | | | | |
| | (C3) | | | | | 20.6 | | | | | | | | | |
| | (C4) | | | | | | 20.6 | | | | | | | | |
| (D)imidazole compound having | (D1) | 2.1 | | | 2.1 | 2.1 | 2.1 | 1.8 | 2.2 | 2.8 | 2.3 | 2.3 | | 1.7 | 2.5 |
| the triazine ring | (D2) | | 2.1 | | | | | | | | | | | | |
| | (D3) | | | 2.1 | | | | | | | | | | | |
| (E) inorganic filler | (E1) | 20.6 | 20.6 | 20.6 | 20.6 | 20.6 | 20.6 | 18.2 | 21.5 | 28.4 | 22.9 | 23.1 | 18.9 | 17.3 | 24.5 |
| Viscosity | Pa · s | 32 | 32 | 32 | 33 | 34 | 28 | 41 | 58 | 11 | 38 | 27 | 33 | 35 | 24 |
| The ratio of viscosity after 8 hours | % | 1.1 | 1.1 | 1.1 | 1.0 | 1.1 | 1.2 | 1.2 | 1.0 | 1.2 | 1.0 | 1.2 | 1.0 | 1.0 | 1.1 |
| at 25° C. to initial viscosity, % | | | | | | | | | | | | | | | |
| Initial adhesive strength | MPa | 46 | 39 | 42 | 44 | 51 | 53 | 54 | 51 | 39 | 55 | 47 | 51 | 44 | 43 |
| Adhesive strength retention rate | % | 81 | 87 | 84 | 87 | 83 | 76 | 71 | 84 | 80 | 91 | 91 | 90 | 79 | 83 |
| after storage at high-temperature and | | | | | | | | | | | | | | | |
| high-humidity for 48 hr | | | | | | | | | | | | | | | |

TABLE 2

| | | Example | | | | | | | | | | | |
|---|---|---|---|---|---|---|---|---|---|---|---|---|---|
| | | 15 | 16 | 17 | 18 | 19 | 20 | 21 | 22 | 23 | 24 | 25 | 26 |
| (B1) phenolic hydroxyl group/(A1)epoxy group, | | 1.0 | 1.0 | 1.0 | 1.0 | 1.0 | 1.0 | 1.0 | 1.0. | 1.0 | 1.0 | 1.0 | 1.0 |
| molar equivalent ratio | | | | | | | | | | | | | |
| (A1) epoxy resin | | 100 | 100 | 100 | 100 | 100 | 100 | 100 | 100 | 100 | 100 | 100 | 100 |
| (B1) liquid phenolic resin | | 85.2 | 85.2 | 85.2 | 85.2 | 77.0 | 80.0 | 91.9 | 100.5 | 123.6 | 85.2 | 85.2 | 85.2 |
| (C1) microcapsule-type curing accelerator | | 20.6 | 20.6 | 20.6 | 20.6 | 4.5 | 9.5 | 33.9 | 50.1 | 95.9 | 20.6 | 20.6 | 20.6 |
| (D1) imidazole compound having the triazine | | 0.2 | 1.0 | 3.1 | 4.1 | 1.8 | 1.9 | 2.3 | 2.5 | 3.2 | 2.1 | 2.1 | 2.1 |
| ring | | | | | | | | | | | | | |
| (E1) inorganic filler | | 20.6 | 20.6 | 20.6 | 20.6 | 18.2 | 18.9 | 22.6 | 25.1 | 32.0 | 205.8 | 823.1 | 1646.1 |
| Viscosity | Pa · s | 31 | 31 | 32 | 34 | 22 | 25 | 39 | 45 | 55 | 88 | 193 | 321 |
| The ratio of viscosity after 8 hours | % | 1.0 | 1.0 | 1.1 | 1.2 | 1.0 | 1.0 | 1.1 | 1.2 | 1.2 | 1.1 | 1.1 | 1.2 |
| at 25° C. to initial viscosity, % | | | | | | | | | | | | | |
| Initial adhesive strength | MPa | 38 | 44 | 51 | 57 | 36 | 40 | 52 | 55 | 53 | 61 | 71 | 72 |
| Adhesive strength retention rate | % | 73 | 80 | 82 | 76 | 88 | 92 | 83 | 80 | 75 | 90 | 93 | 94 |
| after storage at high-temperature | | | | | | | | | | | | | |
| and high-humidity for 48 hr | | | | | | | | | | | | | |

TABLE 3

| | | Comparative Example | | | | | | |
|---|---|---|---|---|---|---|---|---|
| | | 1 | 2 | 3 | 4 | 5 | 6 | 7 |
| (B1) phenolic hydroxyl group/(A1)epoxy group, | | 1.0 | 1.0 | 1.0 | 1.0 | 1.0 | 1.0 | 1.0 |
| molar equivalent ratio | | | | | | | | |
| (A1) epoxy resin | | 100 | 100 | 100 | 100 | 100 | 100 | 100 |
| (B1) liquid phenolic resin | | 85.2 | 85.2 | 74.5 | 74.5 | 85.2 | 85.2 | |
| (B1′) epoxy resin curing agent | | | | | | | | 67.9 |
| (C1) microcapsule-type curing accelerator | | 20.6 | 20.6 | | | 20.6 | 20.6 | 18.7 |
| (D1) imidazole compound having the triazine ring | | 2.1 | | 2.1 | 8.7 | | | 1.9 |
| (E1) inorganic filler | | | 20.6 | 20.6 | 20.6 | 20.6 | 20.6 | 18.7 |
| (F1) imidazole compound | | | | | | 2.1 | | |
| (F2) triazine compound | | | | | | | 2.1 | |
| Viscosity | Pa · s | 28 | 31 | 25 | 73 | 35 | 34 | N.D. |
| The ratio of viscosity after 8 hours | % | 1.1 | 1.0 | 1.1 | 6.4 | 2.8 | 1.8 | N.D. |
| at 25° C. to initial viscosity, % | | | | | | | | |
| Initial adhesive strength | MPa | 31 | 24 | uncured | 23 | 27 | 25 | 28 |
| Adhesive strength retention rate | % | 48 | 42 | uncured | 31 | 36 | 63 | 71 |
| after storage at high-temperature | | | | | | | | |
| and high-humidity for 48 hr | | | | | | | | |

As shown in Table 3, regarding the epoxy resin compositions that do not contain either one of a microcapsule-type curing accelerator and an imidazole compound having a triazine ring (Comparative Examples 2, 3, and 4), the curability of the epoxy resin compositions and the initial adhesive strength and adhesion retention strength of the cured products are inferior, as shown the comparison with the Examples and the Comparative Examples. In particular, the composition of Comparative Example 3, which did not contain a microcapsule-type curing accelerator, was not cured by heating at 200° C. for 1 minute, and was inferior in curability. The epoxy resin composition of Comparative Example 4, which did not contain a microcapsule-type curing accelerator but contained an increased amount of an imidazole compound having a triazine ring, had good curability; however, this composition thickened at room temperature over time, and was inferior in storage stability. The epoxy resin compositions of Comparative Examples 5 and 6, which contained an imidazole compound or a triazine compound in place of an imidazole compound having a triazine ring, were inferior in storage stability at room temperature, and also inferior in initial adhesive strength and adhesion retention strength, as compared to the compositions of the Examples.

In Comparative Example 7, which used a solid epoxy resin curing agent that did not have an aliphatic carbon-carbon double bond, no liquid composition was obtained at 25° C.

In contrast, as shown in Tables 1 and 2, the epoxy resin compositions of the present invention containing a liquid phenolic resin having an aliphatic carbon-carbon double bond, a microcapsule-type curing accelerator, and an imidazole compound having a triazine ring have excellent curability and storage stability and provide cured products with excellent adhesive strength.

The epoxy resin composition of the present invention has excellent curability and storage stability, and can give a cured product with excellent adhesive strength. The epoxy resin composition of the present invention is suitably used as a sealing material or an adhesive in the fields of electrical or electronic equipment parts, and automobile parts.

1. An epoxy resin composition comprising: (A) an epoxy resin, (B) a phenolic resin in a form of liquid at 25° C., having, per molecule, one or more functional groups having an aliphatic carbon-carbon double bond, (C) a microcapsule-type curing accelerator, (D) an imidazole compound having a triazine ring, and (E) an inorganic filler.

2. The epoxy resin composition according to claim 1, wherein the epoxy resin (A) has one or more aromatic rings per molecule.

3. The epoxy resin composition according to claim 2, wherein the epoxy resin (A) comprises one or more selected from the group consisting of a bisphenol A-type epoxy resin, a bisphenol F-type epoxy resin, a naphthalene-type epoxy resin, and an aminophenol-type epoxy resin.

4. The epoxy resin composition according to claim 1, wherein the one the one or more functional groups having an aliphatic carbon-carbon double bond in the liquid phenolic resin (B) is an allyl group or a vinyl group.

5. The epoxy resin composition according to claim 1, wherein the liquid phenolic resin (B) is represented by the following formula (1): 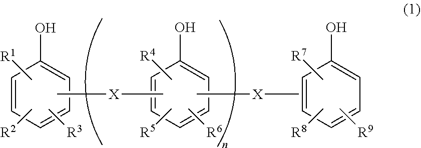
wherein R¹ to R⁹ are, independently of each other, a hydrogen atom, an optionally substituted monovalent hydrocarbon group having 1 to 25 carbon atoms and not having an aliphatic carbon-carbon double bond, an allyl group, a vinyl group, a (meth)acryloxy group, a styryl group, or a hydroxyl group; one or more of R¹ to R⁹ are allyl groups or vinyl groups; n is a number of 0 to 10; and X is a divalent linking group selected from the group consisting of the following formulas: 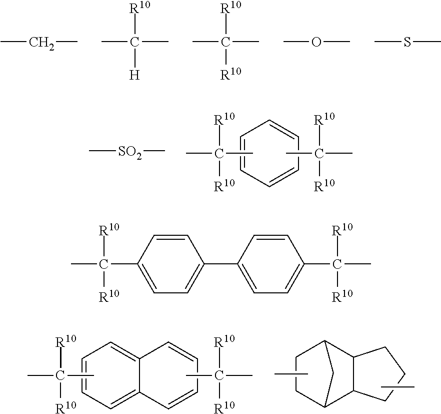
wherein R¹⁰ is, independently of each other, a hydrogen atom or a methyl group.

6. The epoxy resin composition according to claim 1, wherein a molar equivalent ratio of phenolic hydroxyl groups in the liquid phenolic resin (B) is 0.1 to 2.0, per molar equivalent of epoxy groups in the epoxy resin (A).

7. The epoxy resin composition according to claim 1, wherein an amount of the microcapsule-type curing accelerator (C) is 1 to 200 parts by mass, relative to 100 parts by mass of the epoxy resin (A).

8. The epoxy resin composition according to claim 1, wherein the microcapsule-type curing accelerator (C) comprises a core comprising a curing accelerator selected from a phosphorus compound, a tertiary amine compound, an imidazole compound, a urea compound, and an amine adduct compound.

9. The epoxy resin composition according to claim 1, wherein an amount of the imidazole compound having the triazine ring (D) is 0.1 to 5 parts by mass, relative to 100 parts by mass of the epoxy resin (A).

10. The epoxy resin composition according to claim 1, wherein an amount of the inorganic filler (E) is 10 to 20,000 parts by mass, relative to 100 parts by mass of the epoxy resin (A).

11. An encapsulant for a semiconductor element, the encapsulant comprising the epoxy resin composition according to claim 1.

12. An adhesive comprising the epoxy resin composition according to claim 1.

13. A semiconductor device having a cured product of the epoxy resin composition according to claim 1.

14. The encapsulant according to claim 11, wherein the epoxy resin (A) has one or more aromatic rings per molecule.

15. The encapsulant according to claim 14, wherein the epoxy resin (A) comprises one or more selected from the group consisting of a bisphenol A-type epoxy resin, a bisphenol F-type epoxy resin, a naphthalene-type epoxy resin, and an aminophenol-type epoxy resin.

16. The adhesive according to claim 12, wherein the epoxy resin (A) has one or more aromatic rings per molecule.

17. The adhesive according to claim 16, wherein the epoxy resin (A) comprises one or more selected from the group consisting of a bisphenol A-type epoxy resin, a bisphenol F-type epoxy resin, a naphthalene-type epoxy resin, and an aminophenol-type epoxy resin.

18. The semiconductor device according to claim 13, wherein the epoxy resin (A) has one or more aromatic rings per molecule.

19. The semiconductor device according to claim 18, wherein the epoxy resin (A) comprises one or more selected from the group consisting of a bisphenol A-type epoxy resin, a bisphenol F-type epoxy resin, a naphthalene-type epoxy resin, and an aminophenol-type epoxy resin.

20. The epoxy resin composition according to claim 13, wherein the one the one or more functional groups having an aliphatic carbon-carbon double bond in the liquid phenolic resin (B) is an allyl group or a vinyl group.
